(19) United States
(12) Patent Application Publication
(10) Pub. No.: US 2007/0101955 A1
(43) Pub. Date: May 10, 2007

(54) Air intake lengthening structure for model engines

(75) Inventor: Mao-Sheng Lo, Taichung City (TW)

Correspondence Address: BIRCH STEWART KOLASCH & BIRCH, PO BOX 747, FALLS CHURCH, VA, 22040-0747, US

(73) Assignee: FORCE MODELS CO., LTD.

(21) Appl. No.: 11/270,452

(22) Filed: Nov. 10, 2005

(51) Int. Cl. F02B 33/04; F02B 25/00; F02B 25/14

(52) U.S. Cl. 123/73 A; 123/73 R

(57) ABSTRACT

An air intake structure to increase air intake time for model engines includes at least one channel on the bottom wall of an air inlet of a model engine. The channel is inclined and directed inwards from an outer side of the air inlet to mate an opening of an air intake passage formed in the middle portion of a crankshaft. Thereby the amount of fuel gas entering through the passage into a crankshaft chamber can be increased gradually to lengthen fuel gas intake time to achieve a thorough air and fuel mixing. Fuel consumption can be reduced and crankshaft rotation is more stable. Engine performance also can be enhanced.

### FIELD OF THE INVENTION

The present invention relates to the structure of model engines and particularly to an air intake structure to increase air intake time to thoroughly mix fuel gas and enhance engine performance.

### BACKGROUND OF THE INVENTION

Referring to FIGS. 1A and 1B, a conventional two-stroke model engine 1 has four processes during operation that include air intake, compression, combustion and gas exhaustion. Fuel and air are mixed in a carburetor 2 to become fuel gas. The fuel gas passes through an inclined air inlet 4 of the engine 1 and a passage 5 in the middle of a crankshaft 3 to enter a crankshaft chamber 6. A piston 7 driven by the crankshaft 3 through a linkage bar 8 is moved upwards (as shown in FIG. 1A). Then the mixed fuel gas in a combustion chamber of a cylinder 9 is ignited by a spark plug (a) to burn and generate a combustion stroke. A pressure is generated to push the piston 7 downwards as shown in FIG. 1B. When the piston 7 is moved downwards at a selected distance, a gas outlet b on one side of the cylinder 9 is opened, and the mixed fuel gas trapped in the crankshaft chamber 6 is sucked by the piston 7 through the gas outlet (b) into the combustion chamber of the cylinder 9; the exhaust gas generated by the previous combustion is discharged through an exhaust vent (c) on another side of the cylinder 9. One operation cycle of the model engine is therefore completed.

Referring to FIGS. 1A and 2 again, when the crankshaft 3 rotates and an opening of the passage 5 in the middle portion is aligned with a fuel gas injection port d on a lower side of the carburetor 2, a great amount of fuel gas rapidly enters the crankshaft chamber 6 through the passage 5 of the crankshaft 3. The time for mixing the fuel and air is not adequate. And the fuel and air cannot be mixed thoroughly. This results in waste of fuel and not smooth operation of the engine. The torque of the engine at low speed also is lower. The engine rotation speed cannot be increased as desired. Hence engine performance is not desirable.

There is an improvement being developed in the industry that has ditches (not shown in the drawings) formed on the periphery of the crankshaft 3 and extended to the opening of the passage 5 so that the fuel gas ejected from the carburetor flows through a gradually larger channel into the passage 5 of the crankshaft 3 with the rotation angle of the crankshaft 3. The intake time of the fuel gas is lengthened. But such a structure results in a decreasing strength of the crankshaft 3 due to formation of the ditches on the periphery thereof. As a result, the crankshaft fractures easily.

### SUMMARY OF THE INVENTION

In view of the aforesaid disadvantages, the primary object of the invention is to provide an air intake lengthening structure for model engines that mainly has at least one channel on the bottom wall of an air inlet of a model engine. The channel is formed in an inclined manner and directs inwards from an outer side of the air inlet to mate an opening of an air intake passage in the middle portion of a crankshaft so that the amount of fuel gas gradually increases to enter the passage of the crankshaft. As a result, the time of fuel gas intake is lengthened to allow the air and fuel to mix up thoroughly. This can save fuel consumption and make rotation speed more stable. Engine performance improves, and the strength of the crankshaft may be maintained intact.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of a conventional model engine showing air intake and ignition operations.

FIG. 1B is a schematic view of a conventional model engine showing compression and gas exhausting operations.

FIG. 2 is a perspective view of a crankshaft of a conventional model engine.

FIG. 3 is an exploded view of an embodiment of the invention.

FIG. 4 is a sectional view of an engine block of an embodiment of the invention.

FIG. 5 is a sectional view of an embodiment of the invention.

FIG. 6A is a schematic view of an embodiment of the present invention in an operating condition.

FIG. 6B is a schematic view of an embodiment of the present invention in another operating condition.

FIG. 6C is a schematic view of an embodiment of the present invention in yet another operating condition.

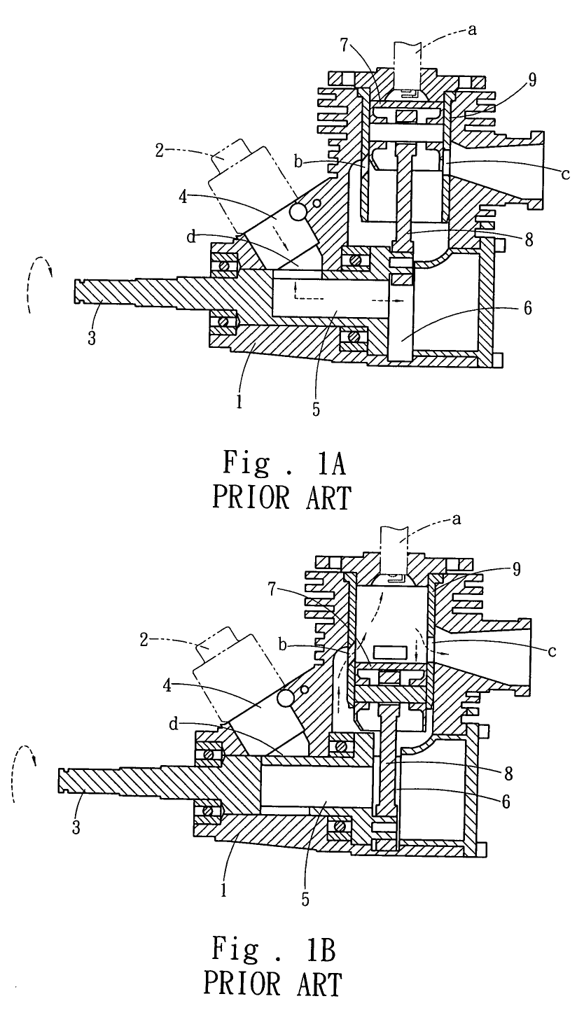

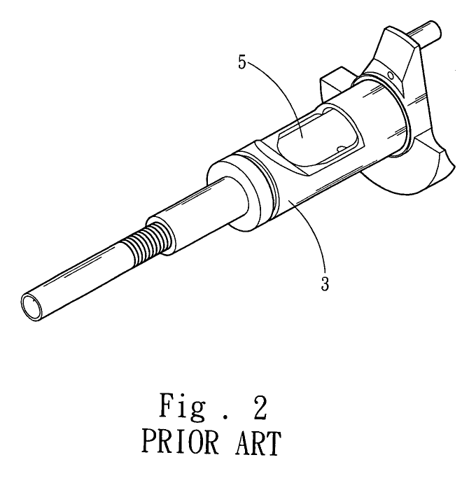

### DETAILED DESCRIPTION OF THE PREFERRED EMBODIMENT

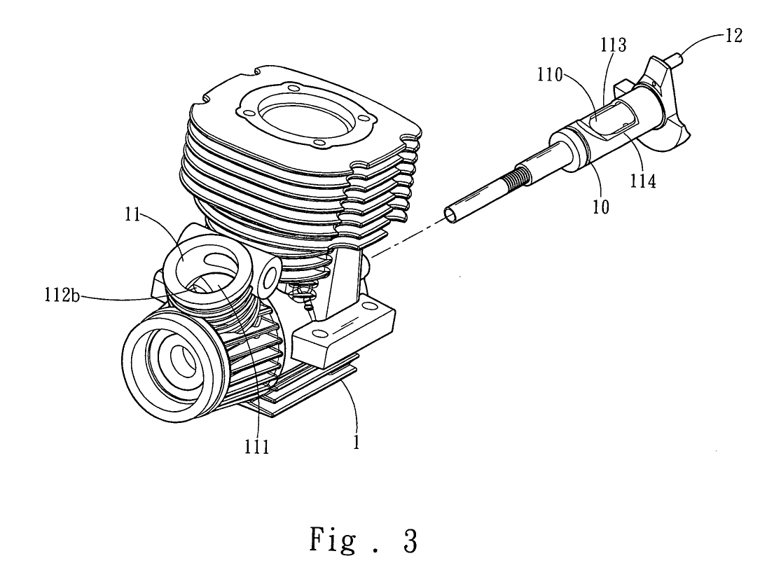

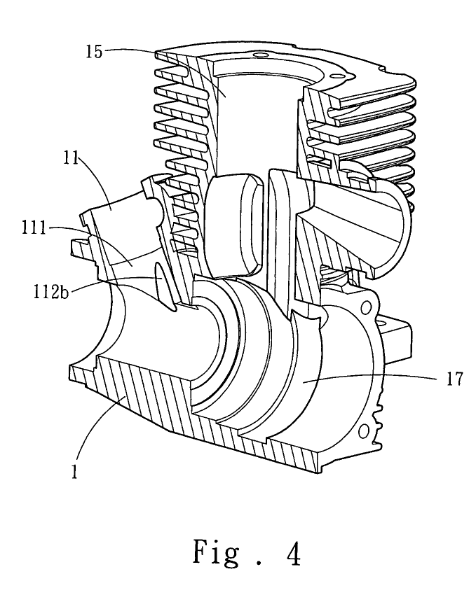

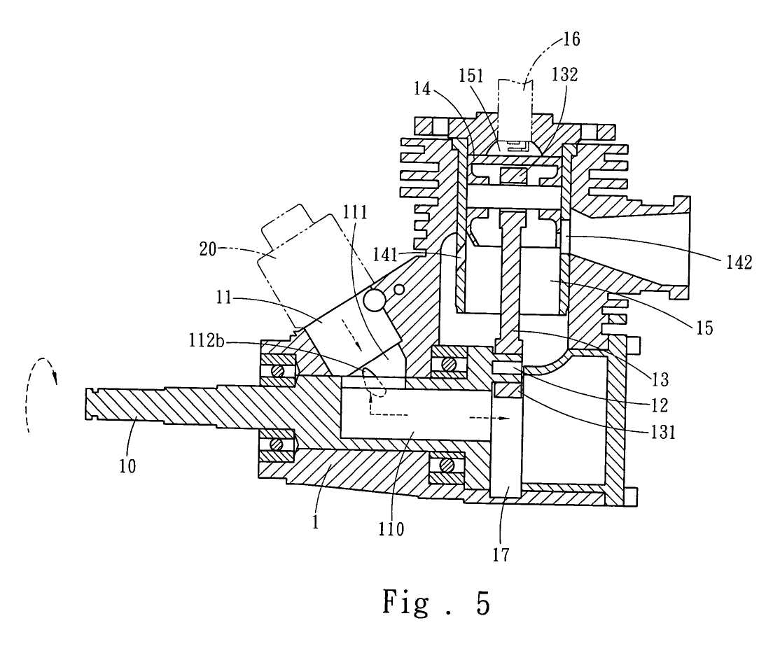

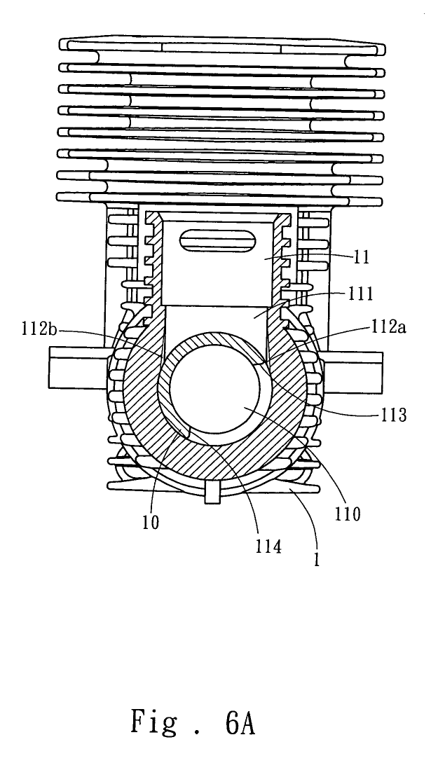

Please referring to FIGS. 3, 4 and 5, the air intake lengthening structure for model engines according to the invention includes a model engine 1 which mainly has a rotary crankshaft 10 and an air inlet 11 leading to an opening of a passage 110 formed in a middle portion of the crankshaft 10 to allow fuel gas ejected from a carburetor 20 to enter a crankshaft chamber 17 formed in the model engine 1. The crankshaft 10 has an axle 12 extended from one end of an inner side thereof. The axle 12 is coupled with a first end 131 of a linkage bar 13. The linkage bar 13 has a second end 132 coupling with a piston 14. The piston 14 has a gas outlet 141 on a side wall and an exhaust vent 142 on another side wall. The piston 14 is located in a cylinder 15 of the model engine 1. The cylinder 15 is coupled with a spark plug 16 on a upper side, and has a combustion chamber 151 on the top portion.

The carburetor 20 is coupled on the air inlet 11 which has a fuel gas injection port 111 on the bottom. The improvement of the invention includes two channels 112a and 112b formed on two opposite inner walls of the fuel gas injection port 111. The channels 112a and 112b are inclined and directed inwards from an outer side of the air inlet 11 so that the bottom has a greater diameter. The fuel gas injection port 111 corresponds to the opening of the passage 110 of the crankshaft 10. The two channels 112a and 112b are parallel with the axis of the air inlet 11.

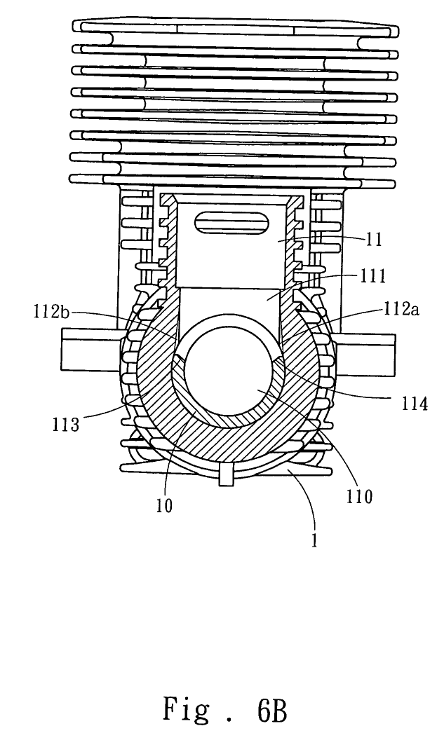

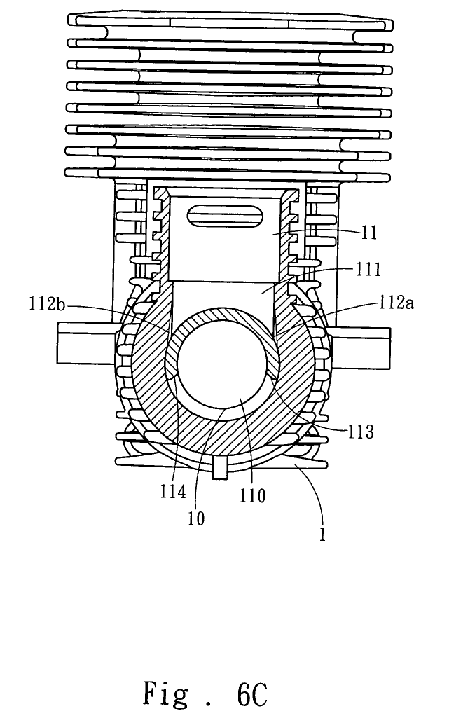

By means of the structure set forth above, referring to FIG. 6A, when the crankshaft 10 rotates counterclockwise, a first edge 113 of the opening of the passage 110 faces the channel 112a, and the bottom of the channel 112a forms a gap with the first edge 113, hence the fuel gas ejected from the carburetor 20 can enter the passage 110 in a small amount, then enters the crankshaft chamber 17. As the crankshaft 10 rotates continuously, the gap between the first edge 113 and the fuel gas injection port 111 becomes bigger until the opening of the passage 110 fully faces the fuel gas injection port 111 to allow maximum amount of fuel gas to enter the passage 110 (referring to FIG. 6B). Then a second edge 114 of the passage 110 is moved close to the other channel 112b so that the amount of the fuel gas entering the passage 110 gradually reduces until another peripheral side of the crankshaft 10 fully covers the fuel gas injection port 111 to form a closed condition as shown in FIG. 6C. Thus the fuel gas ejected from the carburetor 20 has sufficient time to mix up. With the rotation of the crankshaft 10, and through the gradually increasing of the gap between the channel 112a and the opening of the passage 110, and until fully alignment of the passage 110 and the fuel gas injection port 111, injection of the fuel gas into the passage 110 alters gradually from a smaller amount to a greater amount. It is equivalent of lengthening fuel gas intake time into the crankshaft chamber 17. Moreover, as the fuel gas enters the crankshaft chamber 17 gradually from the smaller amount to the greater amount, the fuel ejected from the carburetor 20 can be mixed up with the air thoroughly. This can facilitate complete combustion. As a result, sufficient torque can be generated during low rotation speed of the model engine, and a higher rotation speed also can be achieved. Fuel consumption also can be reduced. And engine performance can be improved.

Prototypes of the invention have been made and tested successfully. The test results have met the expected objects and functions. It provides a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An air intake structure to increase air intake time for model engines comprising a crankshaft and an air inlet leading to a passage formed in a middle portion of the crankshaft to allow fuel gas to enter a crankshaft chamber inside a model engine, the crankshaft having an axle on one end of an inner side coupling with a linkage bar, the linkage bar being coupled with a piston, the piston being located in a cylinder in the model engine, the cylinder having a spark plug on a upper side, the model engine further having a carburetor located on the air inlet which has a fuel gas injection port on the bottom, the fuel gas injection port having at least one channel on an inner wall, the channel being inclined and directed inwards from an outer side of the air inlet to form a greater bottom diameter, the fuel gas injection port corresponding to an opening of the passage of the crankshaft.

2. The air intake lengthening structure of claim 1, wherein the channel of the fuel gas injection port is parallel with the axis of the air inlet and contains two opposing channels.
